(19) United States
(12) Patent Application Publication
(10) Pub. No.: US 2005/0021455 A1
(43) Pub. Date: Jan. 27, 2005

(54) On-line payments system

(76) Inventor: Paul Webster, Hornchurch (GB)

Correspondence Address: Gregory J Lavorgna Esq;Drinker Biddle & Reath LLP, One Logan Square, 18th & Cherry Streets, Philadelphia, PA, 19103-7595, US

(21) Appl. No.: 10/499,099

(22) PCT Filed: Dec. 9, 2002
(86) PCT No.: PCT/GB02/05561

(30) Foreign Application Priority Data
Dec. 17, 2001 (GB) 0130107.6

(51) Int. Cl. G06F 17/60

(52) U.S. Cl. 705/39

(57) ABSTRACT

Payments for purchases made from web sites may be effected by pre-registering customers and merchants. Customers and merchants are assigned at least one virtual account and a public and a private account number. Customers deposit funds into a system collection account and their virtual accounts are credited by the same amount. Purchases are made online by requesting a transfer of the purchase price from the customer virtual account to the merchant virtual account accompanied by the customer's private account number. The merchant may access funds in their virtual account by transferring the real amount from the system collection account to their own bank accounts on an instruction accompanied by their private account number.

This invention relates to a method and system for making on-line payments. It is particularly concerned with payments for purchases made on the Internet.

Over the past few years, use of the Internet to purchase goods and services has grown enormously. Similarly, there has been a rapid growth in the concepts and delivery of commerce over the Internet. However, the infrastructure by which customers pay for goods and services has not kept pace with these developments. Providers of e-commerce services (e-tailers) have found that payment processes are critical to their operations and that existing payment mechanisms are inadequate for supporting e-commerce.

The great majority of on-line payments are made using credit or debit cards. However, credit cards are unsatisfactory for two main reasons: security and cost. Customers are reluctant to disclose credit card information on-line for fear of fraud. It has been found that the major reason that customers abandon on-line purchases is a reluctance to enter credit card information. Whilst the actual likelihood of credit card information being misappropriated can be limited by use of secure connections and encoding, the public perception is such that many potential customers will not use credit cards to shop on-line.

The suspicion of credit cards is not limited to customers. In the event of fraudulent transactions, the liability resides solely with the merchant. This can lead a reluctance on the behalf of merchants to offer e-commerce services to their customers.

For small purchases, credit cards are uneconomical to a merchant. Typically, a credit card supplier will charge a merchant 2.5% of the purchase cost plus a fixed fee of 30 cents. In addition, the e-tailers may be charged a payment gateway fee of about 30 cents and a further 20 cents in fraud screening costs. For a $40 purchase cost, the total cost of a credit card payment adds up to $1.80, some 4½% of the total purchase price. The percentage is even higher for lower price goods and does not enable merchants to maintain acceptable profit margins.

A further problem with credit cards is that, apart from the USA and United Kingdom, their use is not widespread as a result of which many potential customers have no means of paying for on-line purchases.

Other methods of on-line payment are possible although not widely used. These include direct cash on delivery payment; payments through billing intermediaries; and payment through banks. None is particularly satisfactory.

There is, therefore, a need for an on-line payment method and system that is low cost and sufficiently secure to enable customers to use it without worrying about fraud.

Broadly, the present invention provides a system in which virtual accounts are created for customers and merchants. Customers are provided with public and private account numbers and place funds in a system collection account which are credited to their virtual accounts. When an online purchase is made, using the customer private account reference, the funds are transferred from the customer virtual account to the merchant virtual account. The merchant can access these funds using its private account number to transfer funds from the collection account to their bank account.

More specifically there is provided a method of making payments for on-line purchases, comprising the steps of: registering at least one merchant subscriber and a plurality of customer subscribers; establishing a virtual account for each subscriber; assigning a public account reference and a private account reference to each subscriber; crediting funds to the subscriber virtual accounts in accordance with funds deposited by subscribers in a payment system collection account; transferring funds from a customer subscriber virtual account to a merchant subscriber account on the instruction of the customer subscriber to effect payment to the merchant for an on-line purchase made from the merchant by the customer subscriber; and at the request of the merchant subscriber transferring funds from the system collection bank account to a nominated merchant subscriber bank account and reducing the balance of the merchant subscriber virtual account by the amount of the funds transferred to the merchant subscriber bank account.

The invention also provides an on-line payment system comprising: means for registering at least one merchant subscriber and a plurality of customer subscribers; means for establishing a virtual account for each subscriber; means for assigning a public account reference and a private account reference to each subscriber; means for crediting finds to the virtual accounts in accordance with funds deposited in a collection account by subscribers; means for transferring funds from a customer subscriber virtual account to a merchant subscriber account on the instruction of the customer subscriber to effect payment to the merchant for an on-line purchase made from the merchant by the customer subscriber; and means for transferring funds at the request of the merchant subscriber from the system collection bank account to the nominated merchant subscriber and for reducing the balance of the merchant subscriber virtual account by the amount of the funds transferred to the merchant subscriber.

Embodiments of the invention have a number of advantages. Firstly, the system is low cost. The system operator can charge a transaction fee to the merchant or the customer, as appropriate, but fraud prevention and payment gateway charges are avoided. Second, the system is secure in that there is no need for the customers to disclose any personal information such as their credit card number when making an on-line purchase. Third, on-line purchases may be made by anyone, regardless of whether they have any credit or debit cards or a bank account. Any person may register with the system and make a deposit into the system collection account which is credited to their virtual account. This account is drawn down as they make on-line purchases until such time as the customer deposits more funds into the system collection account.

The system is also suitable for micro-payments which are presently uneconomic using credit cards.

Embodiments of the invention will now be described, by way of example, and with reference to the accompanying drawings, in which:

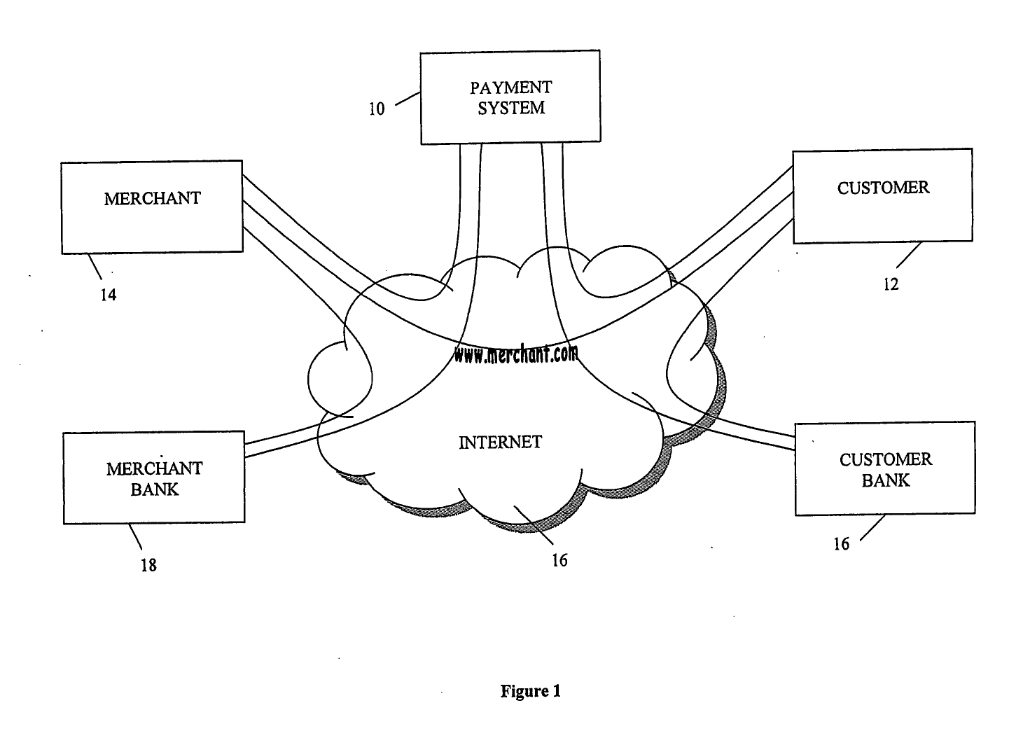

FIG. 1 is a schematic illustration of an on-line payment system embodying the invention;

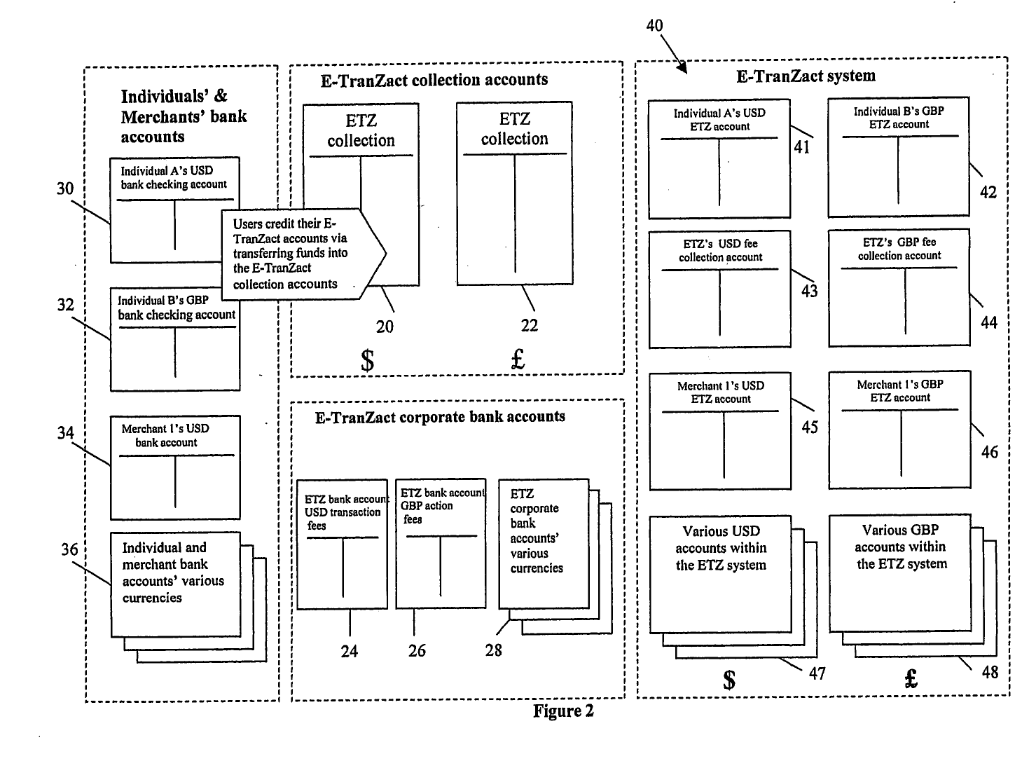

FIG. 2 is a schematic diagram illustrating the setting up of on-line collection accounts;

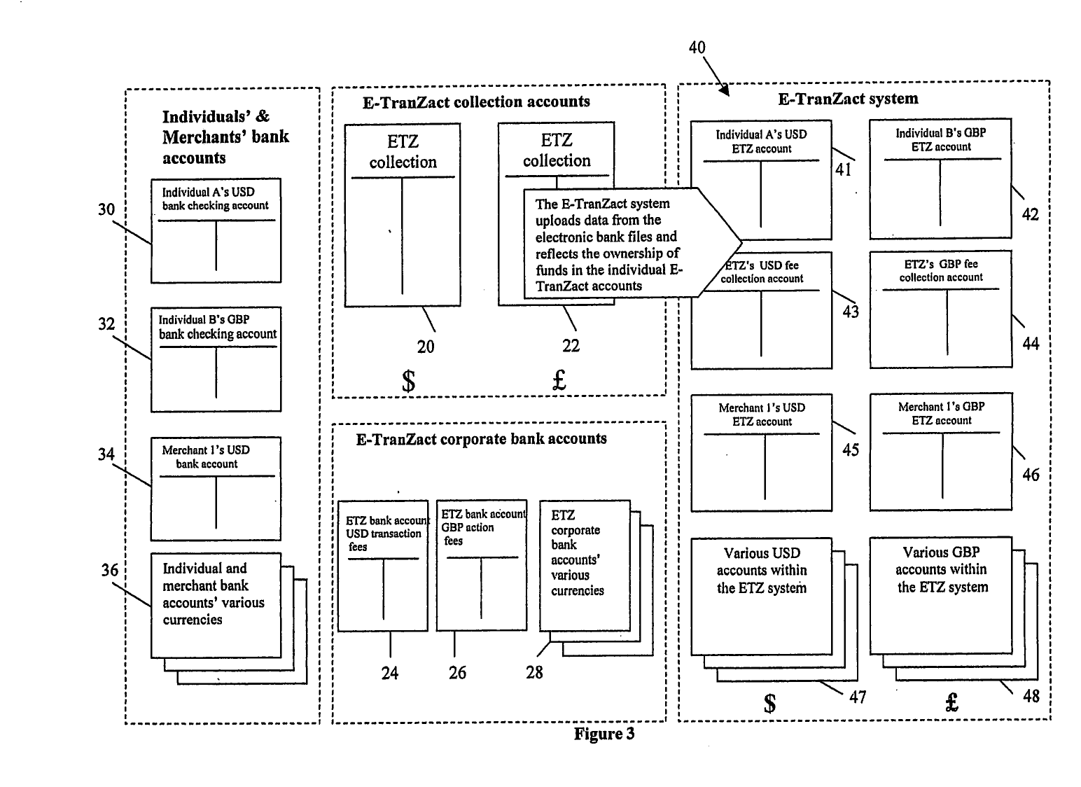

FIG. 3 is a similar view to FIG. 2 showing how collection accounts are entered into a payment system;

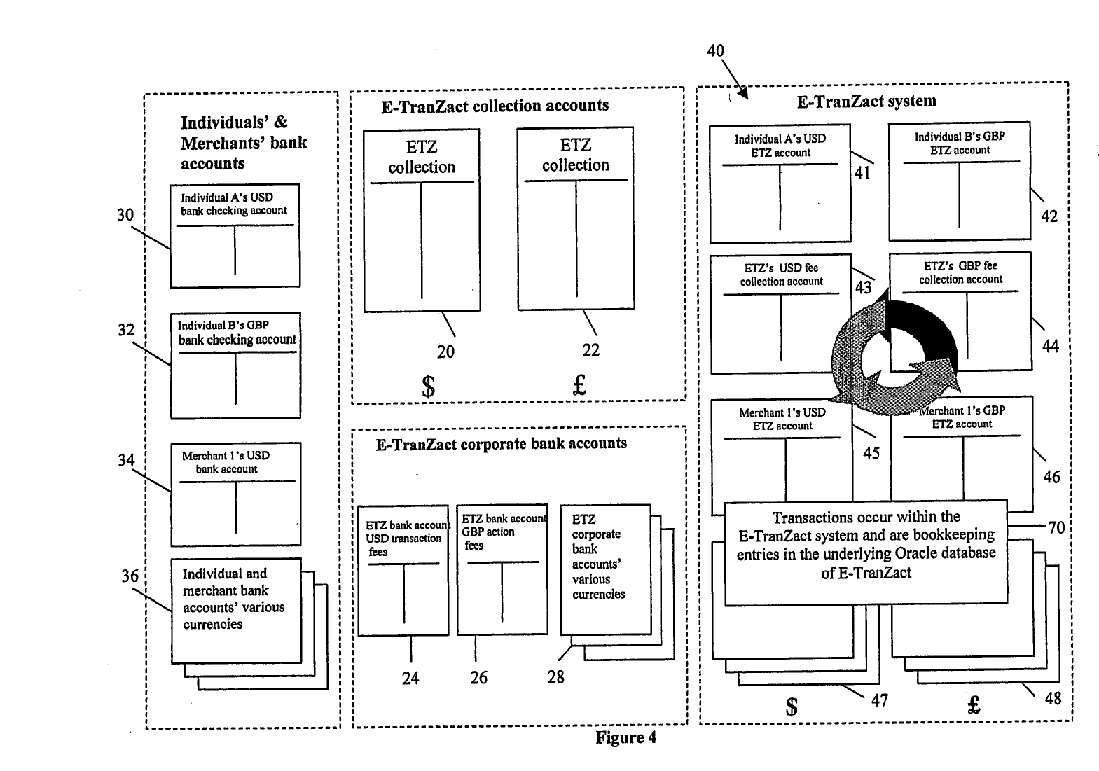

FIG. 4 is a similar view to FIG. 2 showing how on-line transactions take place;

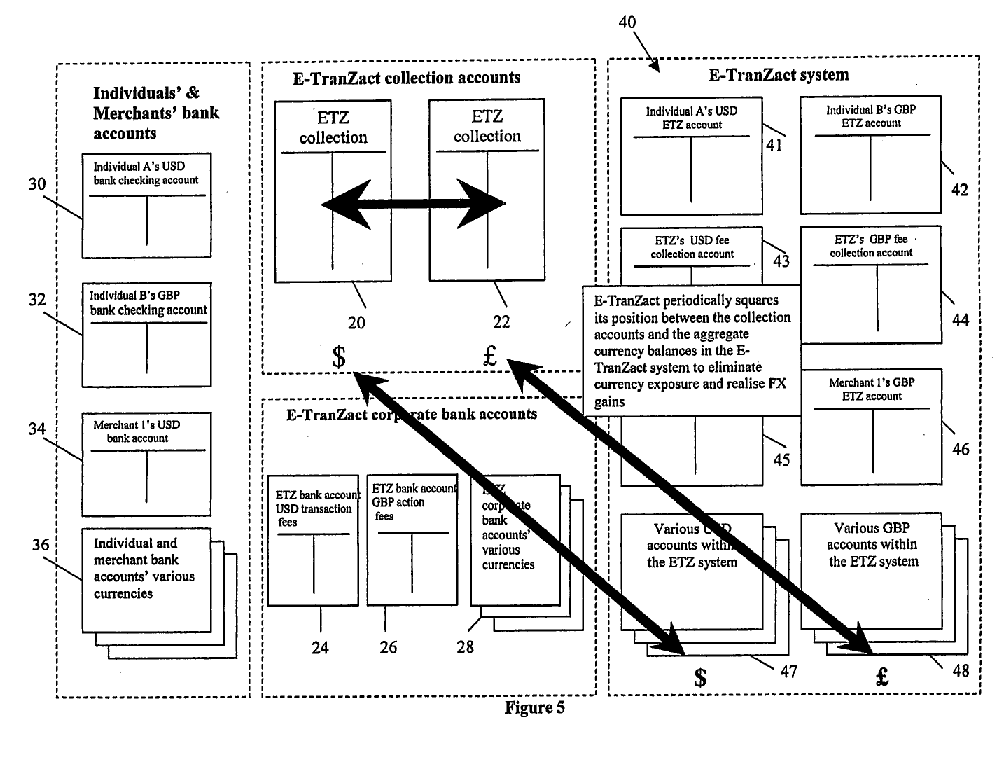

FIG. 5 is a similar view to FIG. 2 showing how currency exposures are handled; and

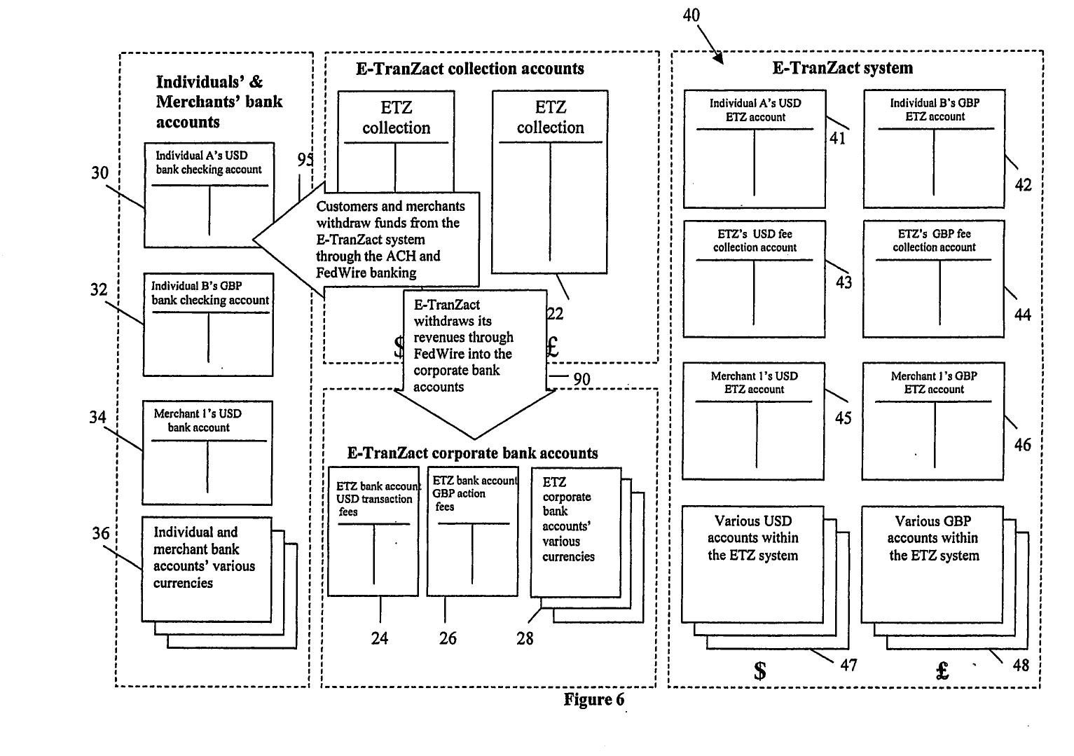

FIG. 6 shows how withdrawals may be made from on-line collection accounts.

Referring to FIG. 1, there is shown schematically, a system for on-line payments in which a payment system 10 interacts, via the Internet 16, with customers 12, their banks 16, merchants 14, from whom the customer wish to make purchases via the merchant web site www.merchant.com, and the merchant's bank 18. The message flow will be described in more detail once the payment system has been described.

FIG. 2 shows a payment system-which uses the existing banking network to channel funds between large corporate collection accounts held by the payment system with its corporate bankers.

The system uses the Internet to provide connectivity between system users globally. Underlying the system is a repository of user accounts and merchant accounts. In hardware terms this may be a suitably programmed conventional relational database such as is provided by Oracle Corp and others.

In FIG. 2 a number of bank accounts are shown schematically including: payment system collection accounts 20, 22; payment system corporate accounts 24, 26, 28; customer bank accounts 30, 32; a merchant bank account 34 and further customer and merchant accounts 36. It will be appreciated that the various accounts will be resident at different banks around the world and may be held in various different currencies.

Thus, the payment system collection accounts include a US$ account 20 and a GB£ account 22 and the payment system corporate accounts include a US$ account 24, a GB£account 26 and various other currency accounts 28. Similarly customer A's account 30 is shown as a US$ account as is merchant account 34. Customer B's accounts 32 is shown as a GB£ account and the further merchant and customer accounts 36 may be in a variety of currencies.

For convenience, the system will only be described using two currencies, GB£ and US$. The payment system comprises a set of virtual accounts 40 which are created for each subscriber users and merchants. Thus in FIG. 2, the payment system 40 comprises virtual US$ and GB£accounts 41, 42 for customers A and B, virtual system collection accounts in US$ and GB£ 43 and 44 and US$ and GB£ merchant accounts 45, 46. It will be appreciated that there are virtual merchant accounts for all currencies handled by the system, here US$ and GB£ only but customers only require virtual accounts in their own currency. In practice, customers may have additional currency accounts if desired. In FIG. 2, further accounts in both GB£ and US$ 47, 48 are shown to indicate other subscribing customers and merchants.

New users of the system can create a virtual account by on-line registration at the payment system web site. These created accounts are, in effect, bookkeeping entries in the underlying system. However, to a user, they appear to be an additional bank account into which they can deposit money to spend on-line.

Each customer can choose the currency in which they will operate their primary account. The account is funded by the user depositing money in the payment system collection account 20, 22 for the chosen currency. This is a real money transfer and may be achieved in a number of ways.

In the on-line environment users may transfer money to the appropriate collection account 20, 22 directly from their bank accounts via an on-line bank transfer. This is a well known technique for transferring funds. Once the system collection account has been registered as a recognised payee, the task of transferring funds is very simple and merely involves specifying the amount and timing of the transfer. The system is preregistered with major banks in the territories in which it operates as a recognised collection account. This approach is simple and reduces errors in the transfer process.

An alternative is to deposit an amount on-line into the collection account using a debit card. This is similar to an on-line transfer and debits an amount directly from the customer's bank account and credits it to the system collection account. This task is performed from the system web site.

Alternatively, users may pay money into the collection account off-line, for example by paying cash or cheques into their system account via a bank or other institution. Funds are deposited into collection accounts using the bank Giro system or its equivalent outside the United Kingdom for cash and cheque deposits. Off-line payments enable the system to be used by anyone, regardless of whether or not they have banks accounts and enable children to use the system, subject to parental controls.

The crediting of a customer's system account by transfer of funds into the system collection account is shown at 50 in FIG. 2.

FIG. 3 shows how the individual virtual accounts are credited with the amount deposited by the customers in their actual system accounts. Account data is uploaded from electronic bank files and reflects the ownership of funds in the individual customer accounts. It should be understood that this is a transfer of account information and not a transfer of funds from the account.

Each system account is assigned two account references which will usually be account numbers. One of these references is a public account reference and the other is a private account reference. The public account reference is used to deposit funds into a customer's system account. Funds cannot be withdrawn using this account number and so it can be disclosed publicly and used to identify the account.

The second account reference or number is disclosed only to the account holder and provides the account holder with access to the funds held in the system account. It is a private number which can only be used by the account holder to access their account from the system web site. Additional security can be provided by making this a secure site with password controlled access.

The system collection accounts 20, 22 receive payments from users which are identified by customers public account numbers. This information is periodically uploaded to the system database of virtual accounts and the amount credited in the collection to a given public account number is credited to the virtual account for that customer. The database holds both the public and private account numbers so that the customer can access the account. It can be seen that no personal information is disclosed in the process of crediting the virtual account held in the system database.

FIG. 4 shows at 70 how transactions between customers and merchants are handled within the system. Transactions are treated as bookkeeping entries within the system. That is, amounts are transferred between the virtual accounts of the customer and the merchant according to the value of the transaction.

Thus, the transactions between users are represented, preferably, by double entry bookkeeping in the system database. This ensures that the transfer of funds between counterparties is correctly recorded. A transfer within the system causes a simultaneous debit and credit between the accounts of the parties to the transaction.

The system operator may raise a charge for each transaction that is handled. This will typically be in the order of several tens of cents, or lower for small value transactions. This may be borne by the merchant in a customer to business transaction or by the buyer in a customer to customer transaction. Other charging models may be used. It will be seen that this method is both secure and cheaper than on-line credit card transactions.

The mechanism for crediting and debiting payments. is satisfactory where the counterparties accounts are in the same currency. This will not always be the case. The system is particularly intended for transactions across the Internet and purchases in other currencies from that of the account holder are likely to be very common. FIG. 5 shows at 80 how these transactions are handled.

If the transfer is a cross currency transaction, the notional funds are exchanged at a rate that is quoted on the system web site to the users. No actual money is redistributed at this stage, merely the change in ownership of funds is recognised within the bookkeeping system in the database.

Periodically, the system squares its position between the collection accounts and the aggregate currency balances of the database. This enables the system to eliminate currency exposure and realise foreign exchange (FX) gains.

Consider the example of a transaction within the system in which a customer in the United Kingdom purchases goods from a United States based web site. Payments in their home currency GB£ have been made to US dollars. Thus, in the bookkeeping system there is a net flow to US$. However, the balance on the US$ collection account does not yet reflect this. This mismatch represents a liability to the users and the physical position of the collection account is a currency exposure. The system is then vulnerable to currency movements.

By monitoring this situation continuously and periodically squaring up, the equilibrium between the two balances can be re-established by transferring funds between the two collection accounts at money market exchange rates. It will be appreciated that a large number of cross currency transactions are lumped into a single money market transfer, that is one transfer involving real money represents many virtual transactions which is highly advantageous as it results in a very low transfer cost per transaction.

FIG. 6 shows how funds can be withdrawn from the system, for example by merchants who want to access payments made by customers or by customers who want to withdraw funds from their system accounts. This is shown at 95.

Withdrawals may be made using the bank payment mechanisms of the country in which the withdrawer is located. The payment mechanism may be a bulk payment system or a Real Time Gross Settlement (RTGS). The latter is commonly used for immediate transfers.

The bulk payment mechanism is suitable for paying out small withdrawals to individuals. Examples of bulk payment systems are BACS in the United Kingdom and the ACH network in the United States.

Merchants will usually want to access funds immediately and utilise high value payments networks that enable RTGS. In the United States a Fedwire transfer is a suitable mechanism. In the United Kingdom a CHAPS transfer is suitable. Most nations have an equivalent payment mechanism.

The system can also withdraw revenues obtained from transaction charges into various currency corporate accounts 24, 26, 28. This is shown at 90 and may be achieved through Fedwire transfer or any other convenient way.

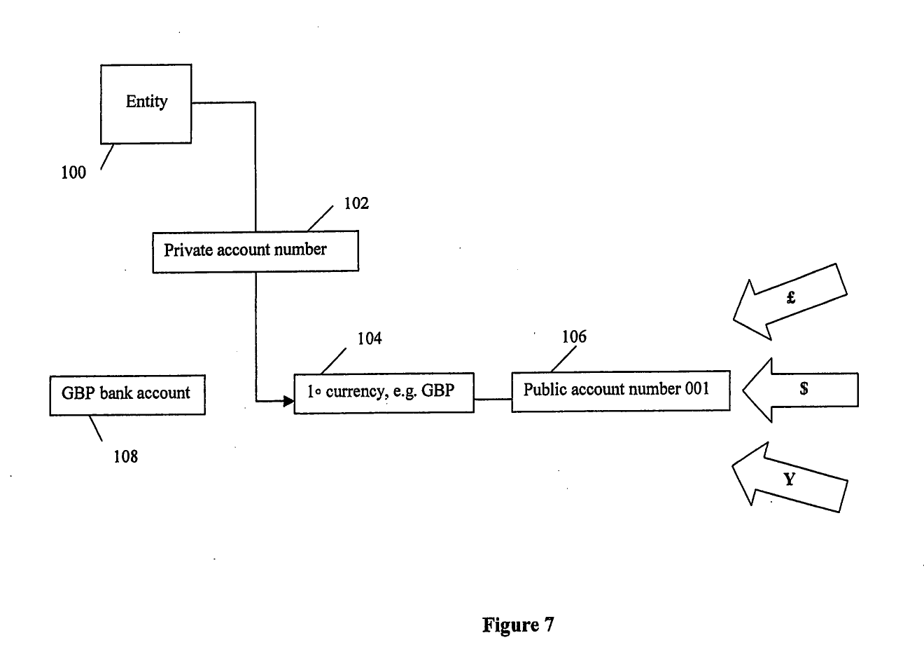

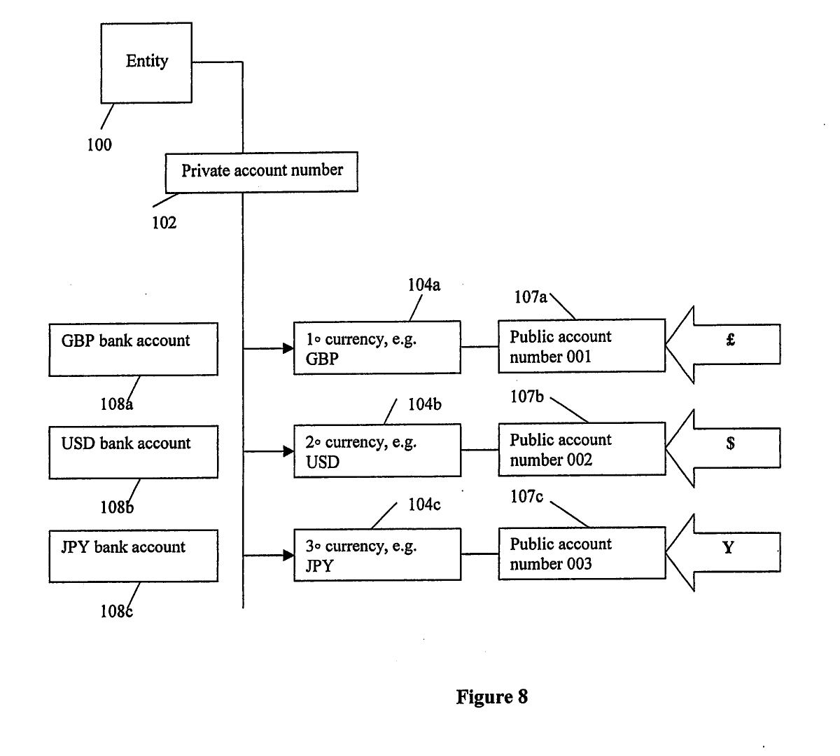

FIGS. 7 and 8 illustrate simplified and more complex account structure respectively. FIG. 7 shows a simply case of an entity 100 who uses a private account number 102 to make purchases from a single currency virtual account 104 and a public account number 106 to credit the virtual account from, for example, their bank 108. Purchases may be made in any currency.

The account structure of FIG. 8 is more complex. Here the entity holds three virtual accounts in the system one each in GBP 104a, USD 104band JPY 104c. These may be funded from different currency bank accounts 108a, 108b and 108c. Each virtual account has a different public account number 107a, 107b, 107c, but a common private account number.

The system described can be used as a banking system in addition to a mere payment system. Referring again to FIG. 8, it is seen that an account may have a number of sub-accounts, 104a, 104b, 104c. These accounts may be used by a system user to transfer monies between the accounts to benefit from movements in foreign exchange rates.

As an example, a user may have set up a private account number that identifies the main account which is in GB sterling. That account also has a public account number associated with it. There is also a sub-account in US dollars identified by another public account number. The user can transfer money from his sterling to US dollar account effectively buying US dollars. As an example, when the transfer is first made, the rate at which the user buys is 1 GBP=1.5050USD. After a period of time, the GBP:USD rate changes to 1 GBP=1.4850 USD. The user now chooses to transfer the US dollars back to sterling. Thus, the user benefits from the movement in the foreign exchange rates.

Thus, the system provides a multi-currency banking system.

It will be appreciated from the example given above that any system that acts as a payment system is a money transfer system which can either be used to transfer money to counterparties or to transfer money within a single user, or group of users'accounts.

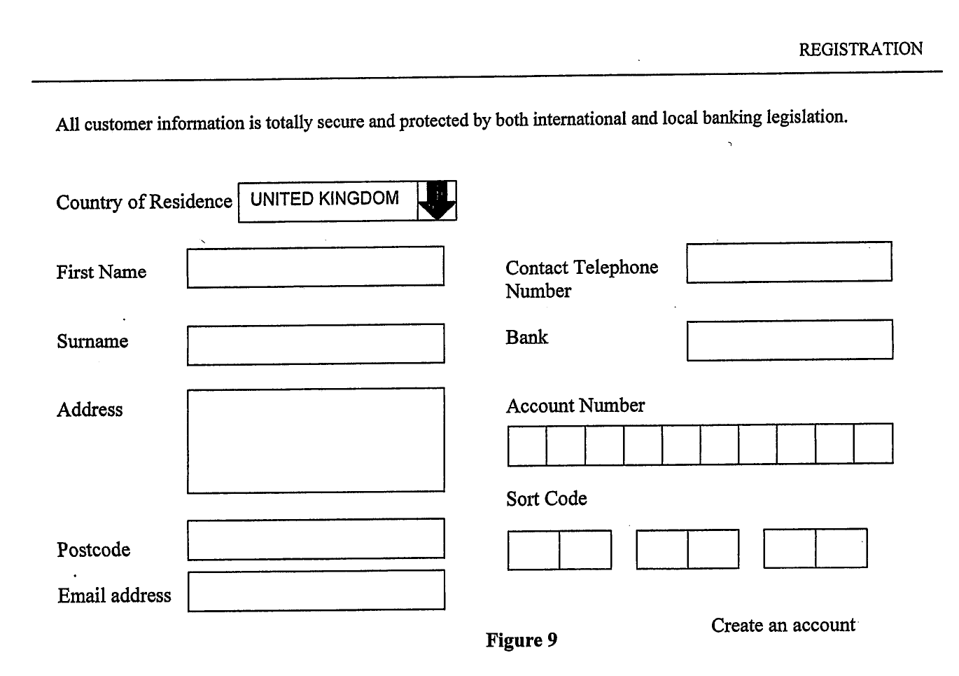

FIG. 9 to 16 show various screen shots of the user interface that a customer experiences when accessing the system web site. FIG. 9 is a registration screen for new customers which asks the customer for personal details including country of residence, name, address, e-mail address, contact telephone number and bank details. Once these have been entered, a virtual account can be created in the system database and public and personal account numbers can be issued.

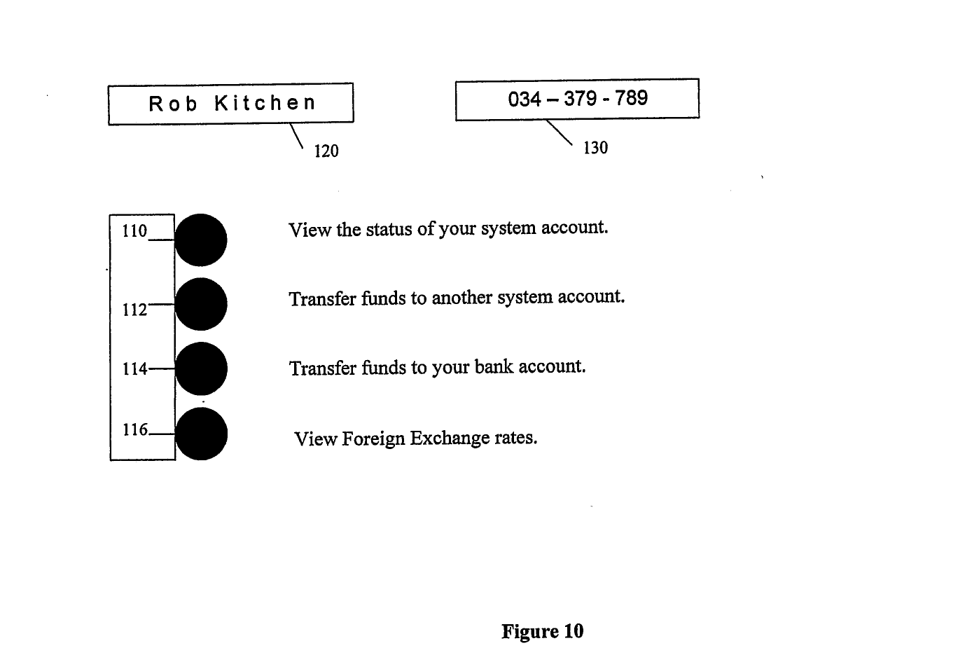

FIG. 10 shows a menu screen that the customer sees once he has logged on to the system by entering his personal account number and name. The menu screen displays the user name 120 and public account number 130. It gives the customer four options: to view the status of their account 110; to transfer funds to another system account 112; to transfer funds to their own bank account 114; and to view the exchange rates used by the system in converting between currencies 116.

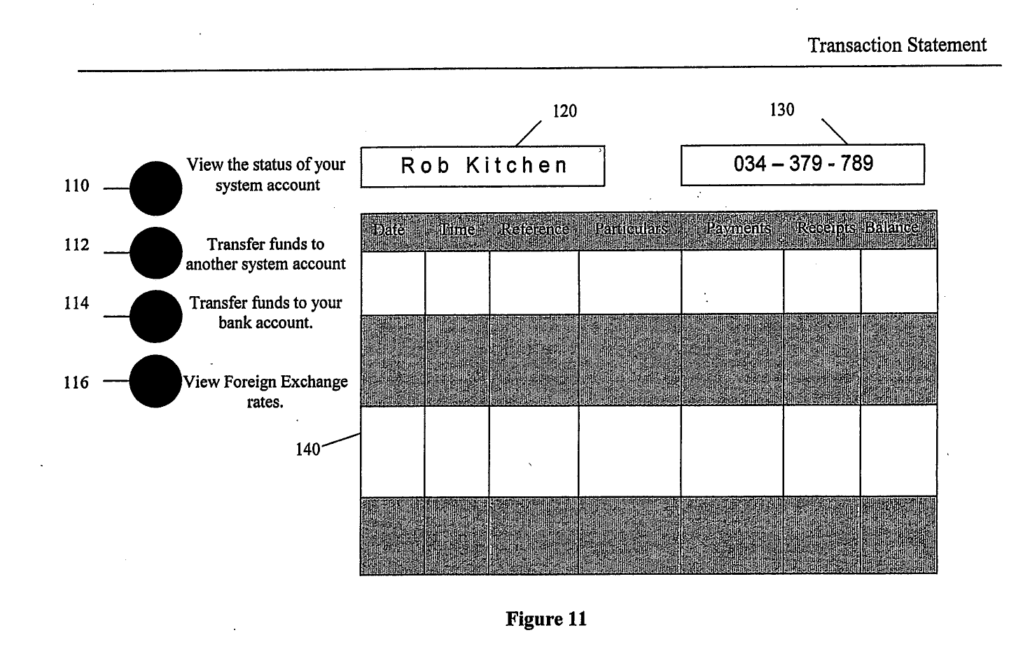

FIG. 11 shows a transaction statement screen which is displayed if the customer selects the account status view option 110 from the menu. The display shows a display 140 of the date, time, reference, particulars, payment amount, receipt amount and balance for each transaction that has been handled on behalf of the customer. Other options may be displayed and this is only an illustrative example.

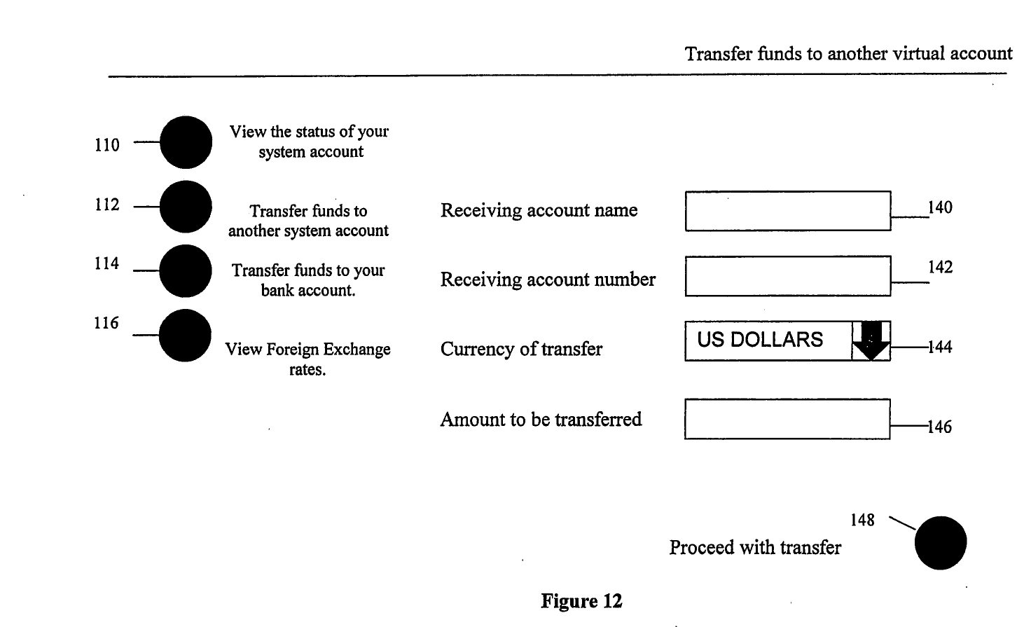

FIG. 12 shows a funds transfer screen that is displayed when the customer selects the second menu option, to transfer funds to another account. The screen asks the customer for the name 140 and public account number 142 of the party to receive the payment, the currency 144 and the amount 146 of the transfer. Finally, the bottom right hand corner has a button 148 for the customer to click to indicate that they wish to proceed with the transfer.

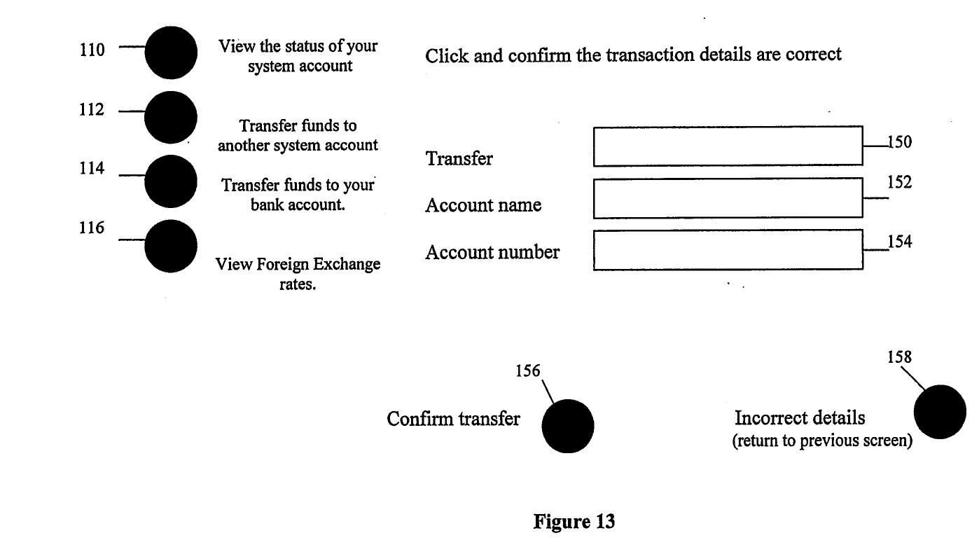

FIG. 13 shows a screen displayed to the customer after they have sent the screen of FIG. 12 displaying the transfer currency and amount 150 and the public account number 152 and name of the party 154 to which the funds are transferred. The customer can either confirm the transfer 156 or return to the previous screen 158 if the details are incorrect.

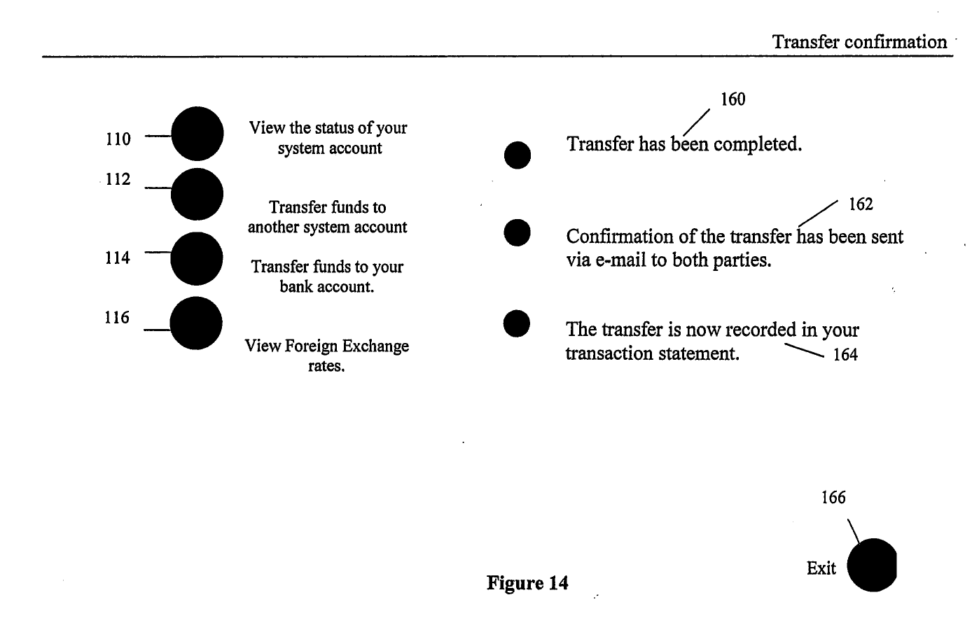

Once the transfer has been completed, the screen of FIG. 14 is displayed to the customer confirming that the transfer has been completed 160 and that a notification has been sent by e-mail to both parties 162. The customer is also informed that the transaction has been recorded in their transaction statement 164 and gives the customer the option to exit 166 the system or return to another menu option.

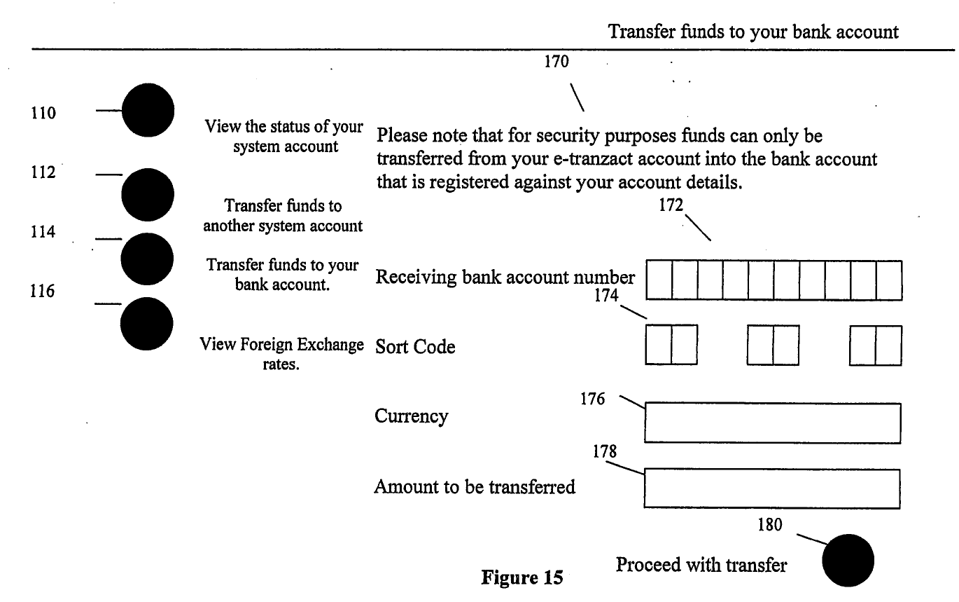

FIG. 15 shows the screen displayed to the customer if he selects the third menu option, transfer of funds to his bank account. Unlike the previous menu option, which only involved transfer of virtual funds between system accounts, this option involves the transfer of a real funds from the system collection account held at the system bank to the customer's bank account. It is the mechanism used by merchants to access funds generated by on-line sales.

The screen informs the customer at 170 that funds can only be transferred to the bank account that they nominated when they registered with the system for security reasons and then asks them for the account number 172, the bank sort code 174, the currency 176 and the amount 178 to be transferred. The user then clicks on a “proceed with transfer” button 180. If the account number entered does not correspond to that stored in the system for the customer the system will not accept the instruction and will ask the customer to re-enter the details.

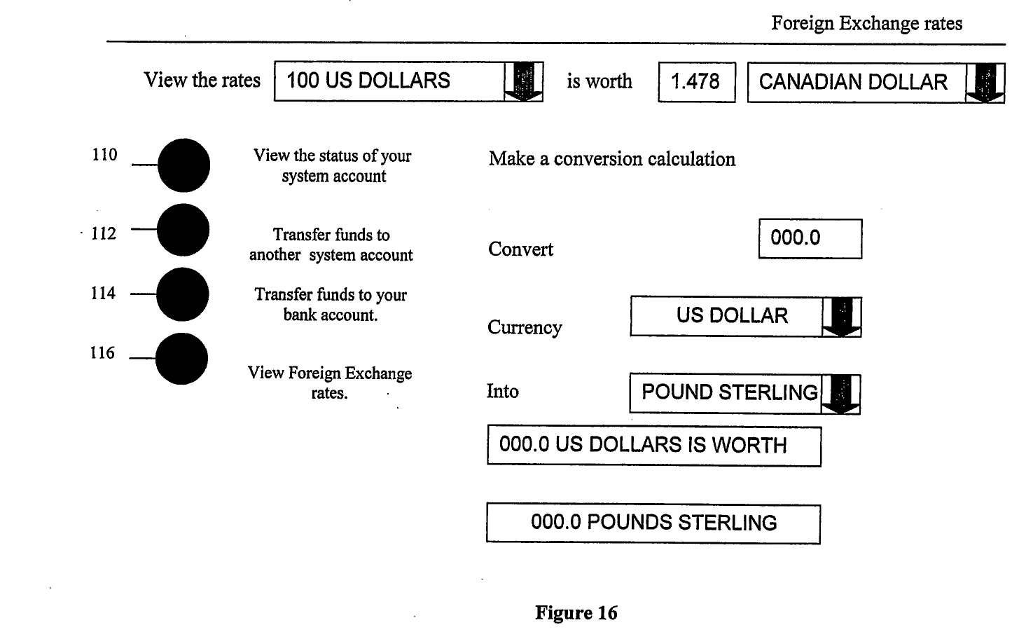

FIG. 16 shows the foreign exchange rates used by the system in handling cross currency transactions and is accessed by selecting the fourth menu option 116. The user can select any currency pair supported by the system to view the exchange rate and then enter an amount to be converted from one currency to another. The screen will then display the value in the second currency of the amount entered in the first currency.

In use, a registered user will access the system from the merchants web site. The user will initially access the merchant's web site and select the goods they wish to purchase. The web site will then ask them how they want to pay. If they select the system embodying the invention they will be transferred to the opening system screen. This may be achieved by clicking a hypertext link or in another other convenient manner. The merchant web site will display its public system account number enabling the customer to direct funds from its own virtual system account to the merchant's virtual system account.

It will be appreciated that the embodiments described provide a number of advantages over conventional on-line payment mechanisms both to consumers and to merchants. It allows consumers to make payments on-line anywhere in the world including at overseas web sites where, at present, many international orders are rejected due to the complexities of screening out fraud. The user may hold accounts in multiple foreign currencies without any minimum balance restrictions or without service charges. Foreign Exchange may be conducted at rates which are more competitive than are offered when using credit cards or High Street banks.

Moreover, transfers between accounts are instantaneous and no personal information is divulged in the transaction process. The system is open to any person who has registered with the system. There is no need for that person to have a bank account and so enables younger people, in particular, to shop on-line in a safe and controlled environment.

For merchants, the system offers a safe payment environment which is free of delays and which is very much cheaper than present credit card payment mechanisms. The cost will depend on the cost levied to the merchant by the system operator but payment gateway and fraud screening costs are eliminated, as are credit card charge-back fees and penalties.

The system enables the merchants to reach a wider customer base as customers without credit cards, and those reluctant to divulge credit card details can shop on the system. Moreover, micropayments are economic to process and international transactions are accepted with the same certainty and cost as domestic transactions.

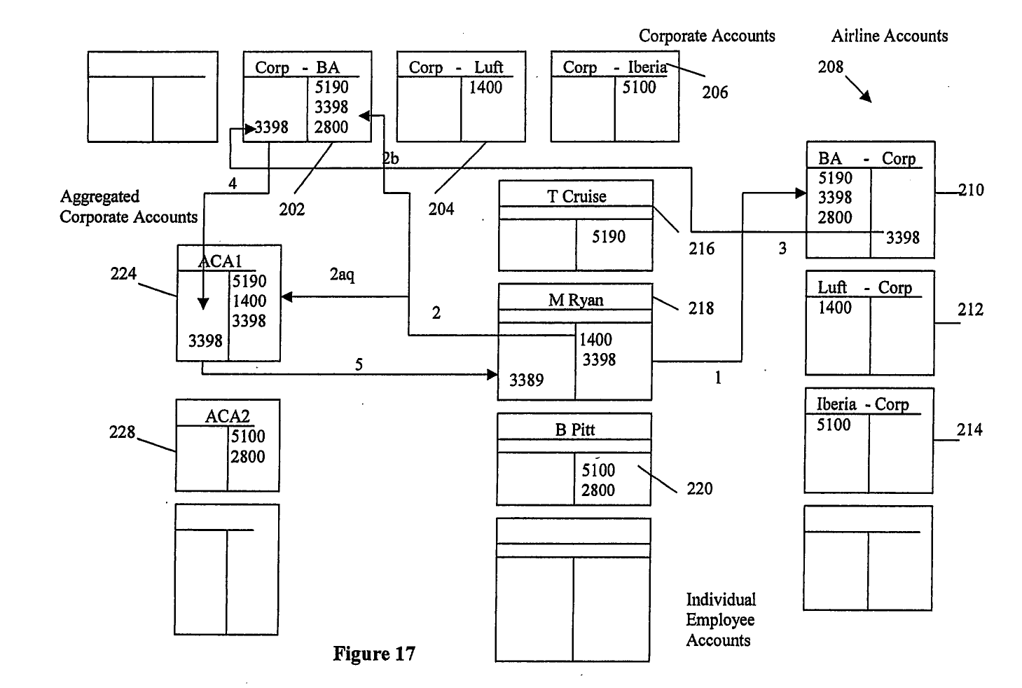

FIG. 17 shows how the system described above maybe used in a corporate environment to enable corporate employees to transact business with service providers to the corporation. The example shown relates to the purchase of air line tickets for employees although this is merely one example of many.

In FIG. 17, corporate accounts 202, 204, 206 are set up for the company for each of three airlines. The company is identified by the initials Corp and the accounts are shown as Corp-BA 202, Corp-Luft 204 and Corp-Iberia 206. Similarly, counterpart airline accounts 208 are set up which are mirrors of the corporate accounts. Thus, accounts 210, 212 and 214 are for BA-Corp, Luft-Corp and Iberia-Corp. Individual employee accounts are also set up. In FIG. 17, accounts for three employees: T Cruise 216, M Ryan 218 and B Pitt 220 have been set up. Further individual accounts may also exist. Furthermore aggregated corporate accounts are set up identified as ACAL 224 and ACA2 226.

The corporation has complete control over the transactions initiated by employees and may set acceptable airlines and spending limits. Transactions initiated by employees can be aggregated back up the corporate structure in any desired combination. These are represented by the aggregated corporate account 224, 226. As explained in the above description, the structure of the system is such that both the corporate's accounts and those of the airline reflect balances owed and owing. Refunds may be netted against balances due. New balances due to individual airlines can be simply reconciled back to the individual employees or some other cost sender or line of service up the corporate hierarchy.

As discussed above, payments to counterparties are initiated and accomplished within the transaction system ensuring that appropriate credits and debits are made to both the system accounts and bank accounts. The timing of payments between counterparties can be determined by the agreement governing business between the corporate and service provider. Similarly, the funding and guarantee of funds for moneys spent within the system may be guaranteed by the identity of the corporate entity.

Each transaction is assigned a unique transaction reference number to allow tracking of the transaction within the system. This is necessary, for example, for the purposes of refunds.

In FIG. 17, five stages in a transaction are illustrated. Employee M Ryan of company Corp selects and purchases a return ticket on British Airways to New York for £3,398. This transaction is shown in the individuals system account and also in the BA-Corp account and the Corp-BA account 202. The amount, using the company's aggregation procedure is also reflected in ACA1 aggregation account 224.

The individual user M Ryan then cancels the trip with British Airways and British Airways initiates a refund in the system. The amount is entered on the other side of the BA-Corp airline account 210, the Corp-BA account 202, the individual employee account M Ryan 218 and the aggregated corporate account ACA 224. Each of these refunds will be accompanied by the transaction reference number.

It will be apparent to those skilled in the art that various modifications to the embodiments described are possible without departing from the scope of the invention which is defined by the claims appended hereto.

1. A method of making payments for on-line purchases, comprising the steps of:
registering at least one merchant subscriber and a plurality of customer subscribers;
establishing a virtual account for each subscriber;
assigning a public account reference and a private account reference to each subscriber;
crediting funds to the subscriber virtual accounts in accordance with funds deposited by subscribers in a payment system collection account;
transferring funds from a customer subscriber virtual account to a merchant subscriber account on the instruction of the customer subscriber to effect payment to the merchant for an on-line purchase made from the merchant by the customer subscriber; and
at the request of the merchant subscriber transferring finds from the system collection bank account to the merchant subscriber and reducing the balance of the merchant subscriber virtual account by the amount of the funds transferred to the merchant subscriber.

2. A method according to claim 1, wherein the step of registering a customer or merchant subscriber comprises the step of requesting details of a nominated bank account from the subscriber.

3. A method according to claim 2, wherein the step of crediting funds to a subscriber virtual account comprises depositing funds into the payment system account together with the subscriber public reference.

4. A method according to claim 1, wherein the step of transferring funds from a customer subscriber virtual account to a merchant subscriber account is performed by the system at the request of a customer subscriber accompanied by the customer subscriber private reference.

5. A method according to claim 1, wherein the step of transferring funds from the system collection bank account to the merchant subscriber in accordance with the merchant subscriber virtual account is performed in response to a request from the merchant subscriber accompanied by the merchant subscriber private reference.

6. A method according to claim 1, wherein a merchant subscriber virtual account comprises a plurality of virtual accounts, each account being in a different currency.

7. A method according to claim 1, wherein a customer subscriber virtual account comprises a plurality of virtual accounts, each account being in a different currency.

8. A method according to claim 6, wherein each of the different currency accounts has a unique public reference and a common private reference.

9. A method according to claim 1, wherein an on-line purchase to be made by a customer subscriber is in a different currency to the currency of the customer subscriber account, comprising calculating at an exchange rate fixed by the system, the cost of the purchase in the currency of the customer subscriber virtual account and debiting the customer subscriber virtual account by the calculated amount if the customer subscriber makes the purchase.

10. A method according to claim 1, comprising the steps of:
a customer subscriber accessing a merchant subscriber web site;
a customer subscriber indicating to the merchant subscriber web site that he/she wants to make a purchase;
transferring the customer subscriber to a payment system web site;
entering details of the payment to be made by the customer subscriber to the merchant subscriber with the customer subscriber's private reference, transferring the amount entered from the customer subscriber's virtual account to the merchant subscriber's virtual account; and
notifying the customer subscriber and the merchant subscriber that the finds have been transferred.

11. A method according to clam 10, wherein the notification comprises an e-mail to each of the customer subscriber and the merchant subscriber.

12. A method of making payments for on-line purchases comprising the steps of:
accessing a merchant web site by a customer using a web browser;
selecting an item for purchase at the merchant web site;
on selection of an item for purchase, transferring to a third party payment web site;
entering a pre-assigned private account reference to the payment web site;
entering payment details relating to the item to be purchased into the web site, the details including a pre-assigned public reference for the merchant;
wherein on receipt of the payment details, the payment web site transfers funds for payment of the item from a virtual account for the customer to a virtual account for the merchant.

13. A method according to claim 12, comprising notifying the merchant and the customer when the funds have been transferred to the merchant virtual account.

14. A computer program comprising program code which, when run on a computer system, performs the steps of claim 1.

15. An on-line payment system comprising:
means for registering at least one merchant subscriber and a plurality of customer subscribers;
means for establishing a virtual account for each subscriber;
means for assigning a public account reference and a private account reference to each subscriber;
means for crediting funds to the virtual account in accordance with funds deposited in a collection account by subscribers;
means for transferring funds from a customer subscriber virtual account to a merchant subscriber account on the instruction of the customer subscriber to effect payment to the merchant for an on-line purchase made from the merchant by the customer subscriber; and
means for transferring funds at the request of the merchant subscriber from the system collection bank account to the merchant subscriber and for reducing the balance of the merchant subscriber virtual account by the amount of the funds transferred to the merchant subscriber.

16. A system according to claim 15, wherein the means for registering a customer or merchant subscriber comprises a web page requesting details of a nominated bank account from the subscriber.

17. A system according to claim 16, wherein the means for crediting funds to a subscriber virtual account comprises a collection account into which subscriber funds are received together with the subscriber public reference.

18. A system according to claim 15, wherein the means for transferring funds from a customer subscriber virtual account to a merchant subscriber virtual account comprises a web page requesting details of the funds to be transferred, the customer subscriber private reference and the merchant subscriber public reference.

19. A system according to claim 15, wherein the means for transferring funds from the system collection bank account to the merchant subscriber bank account in accordance with the merchant subscriber virtual account comprises a web page asking the merchant subscriber details of the amount to be transferred and the merchant subscriber private reference.

20. A system according to claim 15, wherein a merchant subscriber virtual account comprises a plurality of virtual accounts, each account being in a different currency.

21. A system according to claim 15, wherein a customer subscriber virtual account comprises a plurality of virtual accounts, each account being in a different currency.

22. A system according to claim 20, wherein the plurality of virtual accounts each have a common private account reference and a common public reference.

23. A system according to claim 15, comprising means for calculating at an exchange rate fixed by the system, the cost to a customer subscriber of an on-line purchase offered in a currency other than the currency of the customer subscriber's virtual account and means for debiting the customer subscriber virtual account by the calculated amount if the customer subscriber makes the purchase.

24. A system according to claim 15, wherein the customer and merchant virtual accounts are stored in a relational database.

25. A money transfer system comprising:
a virtual account for a system user, the virtual account having a public account reference and a private account reference;
at least one sub-account having a public account number different from the public account number of the virtual account, the at least one sub-account being in a different currency to the virtual account;
means for crediting funds to the virtual account in accordance with funds deposited in a collection account by the user; and
means for transferring funds between the virtual account and the at least one sub-account on the instruction of the user.
